(19) United States
(12) Patent Application Publication
(10) Pub. No.: US 2025/0245727 A1
(43) Pub. Date: Jul. 31, 2025

(54) SYSTEMS AND METHODS FOR PRIORITIZING INFORMATION ITEMS FOR THIRD-PARTY PRESENTATION

(71) Applicant: Walmart Apollo, LLC, Bentonville, AR (US)

(72) Inventors: Jongseok Han, Sunnyvale, CA (US); Ankur Bhardwaj, Milpitas, CA (US); Afroza Ali, Los Altos, CA (US)

(21) Appl. No.: 19/025,836

(22) Filed: Jan. 16, 2025

Related U.S. Application Data
(60) Provisional application No. 63/627,516, filed on Jan. 31, 2024.

(51) Int. Cl. G06Q 30/0601

(52) U.S. Cl. CPC G06Q 30/0631; G06Q 30/0633

(57) ABSTRACT

This application is directed to systems and methods for organizing information. In some embodiments, a disclosed method includes receiving a plurality of requests associated with a plurality of items corresponding to a plurality of item types, where each item type includes one or more items; selecting, from the plurality of item types, a subset of target item types that satisfy a predefined type selection criterion associated with the plurality of requests; for each item type of the subset of target item types, selecting a set of boosting items from a set of target items of the respective target item type based on an item score of each of the set of target items; and generating an ordered list of boosting information items for the subset of target item types by consolidating the sets of boosting items of the subset of target item types.

### RELATED APPLICATION

This application claims benefits of U.S. Provisional Application No. 63/627,516, filed Jan. 31, 2024, titled “Systems and Methods for Prioritizing Information Items for Third-Party Presentation,” which is incorporated by reference in its entirety.

### TECHNICAL FIELD

This application relates generally to information processing and, more particularly, to systems and methods for providing information items to be presented by a third-party application.

### BACKGROUND

A cloud-based service platform may operate by presenting information items on a user interface and prompting user actions with a subset of the presented information items. The service platform often collaborates with many third-party platforms to deliver information items to enhance efficiency. The third-party platforms frequently depend on the cloud-based service platform to furnish candidate information items for presentation. When the information items presented by the third-party platforms are selected, users are guided by the third-party platforms to open related information pages on the cloud-based service platform. These third-party platforms maintain control over selecting specific candidate information items for individual users, and occasionally recommends irrelevant information items their users rarely select. Such guidance from third-party platforms to open related information pages on the cloud-based service platform does not consistently result in user actions. This intricate interplay between the cloud-based service platform and third-party platforms underscores the dynamic nature of information dissemination and user interaction with the cloud-based service platform environment.

### SUMMARY

In various embodiments, a system including a non-transitory memory configured to store instructions thereon and at least one processor is disclosed. The at least one processor is configured to receive a plurality of requests associated with a plurality of items corresponding to a plurality of item types. Each item type includes one or more items. The at least one processor is further configured to select, from the plurality of item types, a subset of target item types that satisfy a predefined type selection criterion associated with the plurality of requests. The at least one processor is further configured to for each item type of the subset of target item types, select a set of boosting items from a set of target items of the respective target item type based on an item score of each of the set of target items. The at least one processor is further configured to generate an ordered list of boosting information items for the subset of target item types by consolidating the sets of boosting items of the subset of target item types.

In various embodiments, a computer-implemented method is disclosed. The computer-implemented method includes a step of receiving a plurality of requests associated with a plurality of items corresponding to a plurality of item types, where each item type includes one or more items. The computer-implemented method further includes steps of selecting, from the plurality of item types, a subset of target item types that satisfy a predefined type selection criterion associated with the plurality of requests. The computer-implemented method further includes steps of, for each item type of the subset of target item types, selecting a set of boosting items from a set of target items of the respective target item type based on an item score of each of the set of target items. The computer-implemented method further includes steps of generating an ordered list of boosting information items for the subset of target item types by consolidating the sets of boosting items of the subset of target item types.

In various embodiments, a non-transitory computer readable medium having instructions stored thereon is disclosed. The instructions, when executed by at least one processor, cause at least one device to perform operations including receiving a plurality of requests associated with a plurality of items corresponding to a plurality of item types, where each item type includes one or more items; selecting, from the plurality of item types, a subset of target item types that satisfy a predefined type selection criterion associated with the plurality of requests; for each item type of the subset of target item types, selecting a set of boosting items from a set of target items of the respective target item type based on an item score of each of the set of target items; and generating an ordered list of boosting information items for the subset of target item types by consolidating the sets of boosting items of the subset of target item types.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured to provide a user application to a plurality of tenants, in accordance with some embodiments;

FIG. 2 is a block diagram of a computing device, in accordance with some embodiments;

FIG. 3 illustrates an artificial neural network, in accordance with some embodiments;

FIG. 4 illustrates a tree-based artificial neural network, in accordance with some embodiments;

FIG. 5 illustrates a deep neural network (DNN), in accordance with some embodiments;

FIG. 6 is a flowchart illustrating a training method for generating a trained machine learning model, in accordance with some embodiments;

FIG. 7 is a process flow illustrating various steps of the training method of FIG. 6, in accordance with some embodiments;

FIG. 8 is a flow diagram of a process of providing a plurality of candidate information items to a third-party computer, in accordance with some embodiments;

FIG. 9 is a flow diagram of a process of providing a plurality of candidate information items including a list of boosting information items to a third-party computer, in accordance with some embodiments;

FIG. 10 is a block diagram of an information management system, in accordance with some embodiments;

FIG. 11 is a block diagram of another information management system, in accordance with some embodiments; and

FIG. 12 is a flowchart illustrating a method for managing information, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and ‘interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship. In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

Various embodiments described herein are directed to systems and methods for managing information items (e.g., data items representative of items included in a catalog an associated network environment) to be distributed to one or more third-party computers on a cloud-based service platform. The cloud-based service platform hosts a first user application having a plurality of user accounts associated with a plurality of users. The first user application includes user interfaces on which information items may be displayed to prompt user actions. One or more third-party computer may be associated with a third-party service platform and host a second distinct user application. A user of the first user application may also be a user of the second user application. When the second user application presents an information item provided by the first user application, a user action with the information item may guide the user to a user interface of the first user application presenting information related to the information item. The information item presented by the second user application is selected from a plurality of candidate information items previously provided by a computer system associated with the first user application. The plurality of candidate information items includes an ordered list of boosting information items and a subset of remaining information items. The boosting information items have higher priority levels than the remaining information items, and each boosting information item may have an item score quantitatively indicating its priority level.

In response to user interactions with candidate information items on the second user application, the computer system associated with the first user application may receive a plurality of requests associated with a plurality of items corresponding to a plurality of item types from the second user application. A subset of target item types satisfies a predefined type selection criterion associated with the plurality of requests, and therefore, is selected from the plurality of item types. An example of the predefined type selection criterion requires that the target item types have the highest weighted selection rates among the plurality of item types and that a sum of weighted selection rates of the target item types is at least a predefined portion (e.g., 80%) of a sum of weighted selection rates of all item types associated with the plurality of requests. For each of the subset of target item types, a set of boosting items is selected from a set of target items of the respective target item type based on an item score of each of the set of target items. The computer system generates an ordered list of boosting information items for the subset of target item types by at least consolidating the sets of boosting items of the subset of target item types.

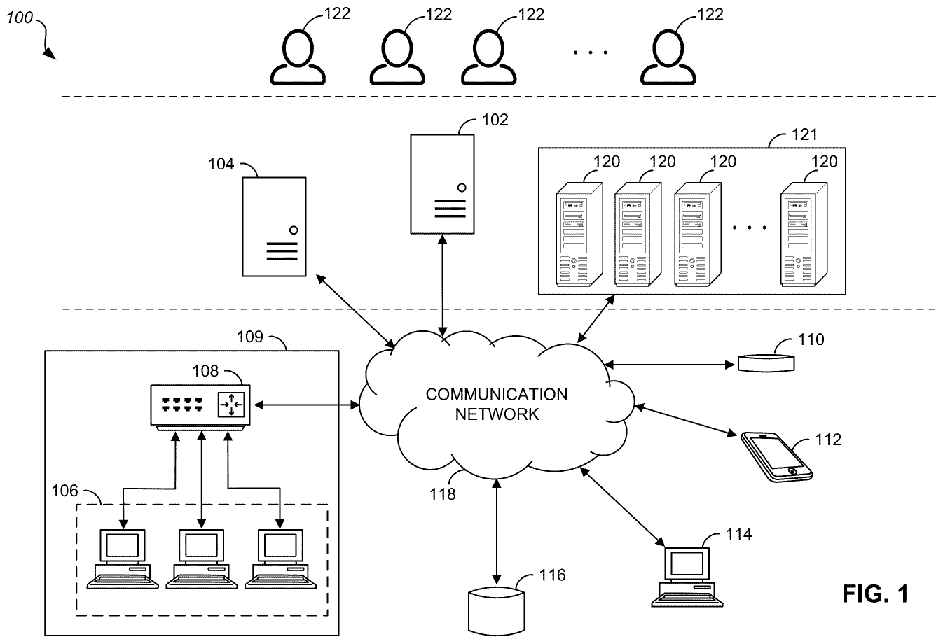

FIG. 1 is a network environment configured to provide a user application (e.g., a network interface application, an online shopping application, etc.) to a plurality of tenants, in accordance with some embodiments. The network environment 100 includes a plurality of devices or systems configured to communicate over one or more network channels, illustrated as a network cloud 118. For example, in various embodiments, the network environment 100 can include, but is not limited to, a recommendation computing device 102 (e.g., a server, such as an application server), a web server 104, a cloud-based engine 121 including one or more processing devices 120, workstation(s) 106, a database 116, and one or more user computing devices 110, 112, 114 operatively coupled over the network 118. The recommendation computing device 102, the web server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the recommendation computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the recommendation computing device 102.

In some examples, each of the user computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more network environments, or portions thereof, such as an e-commerce environment. In some examples, the recommendation computing device 102, the processing devices 120, and/or the web server 104 are operated by a network environment provider, and the multiple user computing devices 110, 112, 114 are operated by users 122 of the network environment. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a physical location 109, for example. The workstation(s) 106 can communicate with the recommendation computing device 102 over the communication network 118. The workstation(s) 106 may send data to, and receive data from, the recommendation computing device 102.

Although FIG. 1 illustrates three user computing devices 110, 112, 114, the network environment 100 can include any number of user computing devices 110, 112, 114. Similarly, the network environment 100 can include any number of the recommendation computing devices 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

Each of the user computing devices 110, 112, 114 may communicate with the web server 104 over the communication network 118. For example, each of the user computing devices 110, 112, 114 may be operable to view, access, and interact with a website, such as an e-commerce website, hosted by the web server 104. The web server 104 may transmit user session data related to a user's activity (e.g., interactions) on the website. For example, a user may operate one of the user computing devices 110, 112, 114 to initiate a web browser that is directed to the website hosted by the web server 104. The user may, via the web browser, login to or otherwise interact with a software application or web application interface, for example. The website may capture these activities as user session data, and transmit the user session data to the recommendation computing device 102 over the communication network 118.

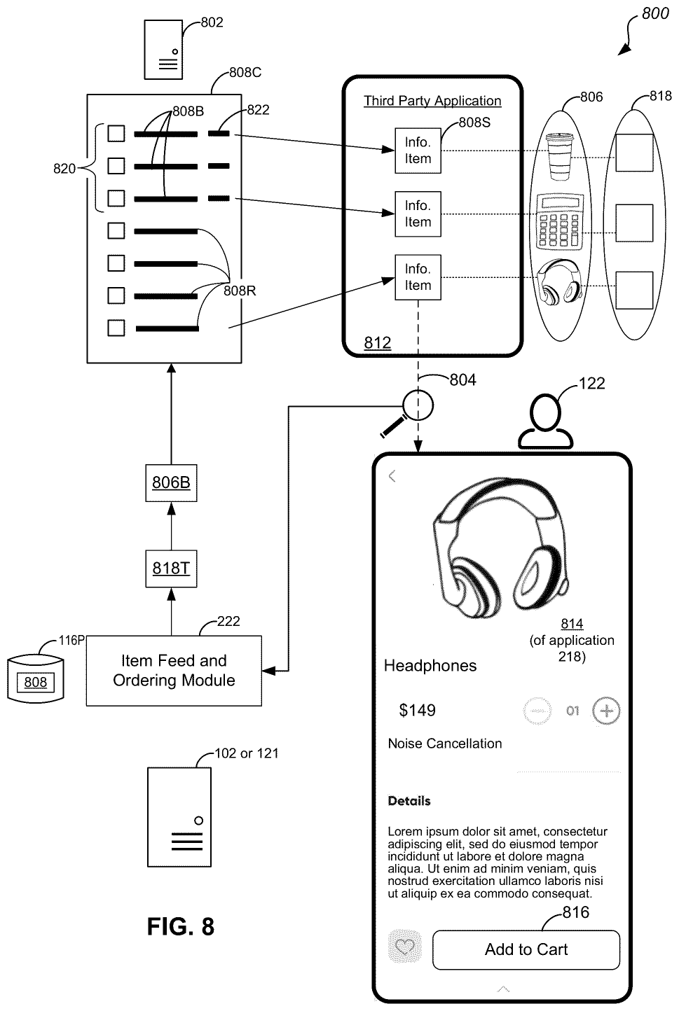

In some examples, the recommendation computing device 102 may execute one or more models, such as a boosting selection model, etc., to identify one or more boosting information items to be provided to a third-party computer (FIG. 8, 802). The recommendation computing device 102 may transmit information of the one or more identified information items to the third-party computer over the communication network 118, and the third-party computer may present the one or more identified information items on a screen of an electronic device associated with a user of a user application executed by the third-party computer.

The recommendation computing device 102 is further operable to communicate with the database 116 over the communication network 118. For example, the recommendation computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the recommendation computing device 102, in some examples, the database 116 can be a local storage device, such as a hard drive, a non-volatile memory, or a USB stick. The recommendation computing device 102 may store purchase data received from the web server 104 in the database 116. The recommendation computing device 102 may also receive from the web server 104 user session data identifying events associated with browsing sessions, and may store the user session data in the database 116.

In some examples, the recommendation computing device 102 generates training data for one or more models (e.g., a type selection model, etc.) based on historical user session data, etc. The recommendation computing device 102 may train the models based on their corresponding training data and may store the model(s) in a database, such as in the database 116 (e.g., a cloud storage).

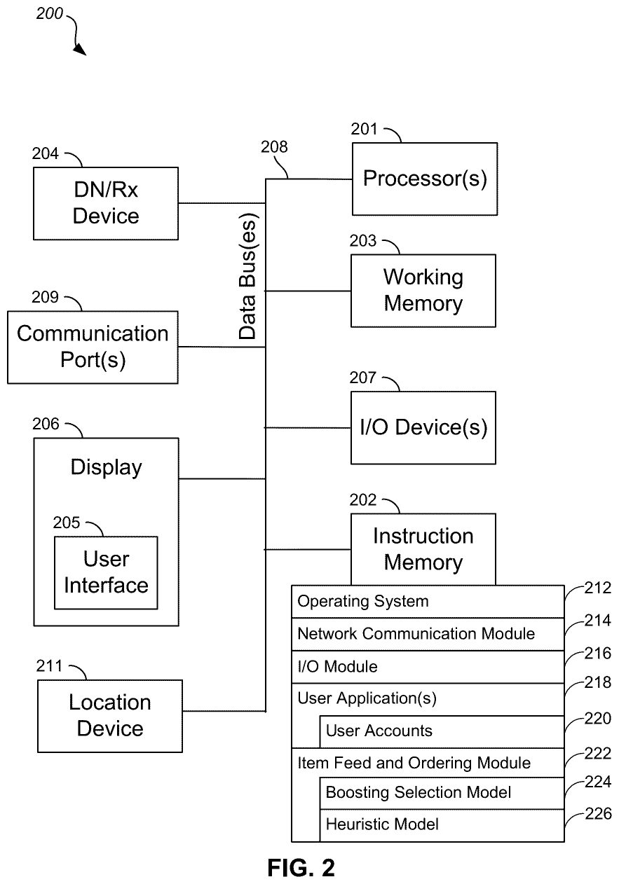

The models, when executed by the recommendation computing device 102, allow the recommendation computing device 102 to recommend and rank interface elements related to information items to be provided to a third-party computer and displayed to a user associated with a user application executed by the third-party computer. For example, the recommendation computing device 102 may obtain the models from the database 116. The recommendation computing device 102 may further execute the models (e.g., a boosting selection model 224 in FIG. 2) to process information associated with a plurality of requests that are received from the third-party computer, generate an ordered list of boosting information items for target item types, and provide to the third-party computer a plurality of information items including both the boosting information items and remaining information items.

In some embodiments, the recommendation computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, recommendation computing device 102 may generate ranked item recommendations for items to be displayed on the website to a user.

In some embodiments, the network environment 100 is configured to provide a user application (e.g., a network interface application, an online shopping application, etc.) to a plurality of users 122. An example of the plurality of users 122 is a plurality of users that share resources via the network environment 100. The user application is deployed for the plurality of users 122, and executed to process requests associated with the plurality of users 122 in the network environment 100 after the plurality of users 122 is authenticated and authorized to access the user application. For example, login pages are displayed on the workstation(s) 106 and the multiple customer computing devices 110, 112 and 114, allowing the plurality of users 122 to provide their credentials (e.g., user names, passwords). In some embodiments, upon authentication, requests associated with the plurality of users 122 (e.g., search requests, purchase requests, account review requests, item recommendation requests) are received from the workstation(s) 106 and customer computing devices 110, 112 and 114.

The network environment 100 is implemented to enable secure concurrent access experience by multiple users 122 of the user application. User interactions (e.g., queries, actions, etc.) of the plurality of users 122 are managed in a centralized manner by the recommendation computing device 102 and/or the cloud-based engine 121. In some embodiments, the recommendation computing device 102 and/or the cloud-based engine 121 receive a plurality of requests associated with a plurality of items corresponding to a plurality of item types. Each item type includes one or more items. The plurality of requests may be received from a third-party computer in accordance with a determination that users of a third-party application interact with information items displayed on a user interface of the third-party application. The recommendation computing device 102 and/or the cloud-based engine 121 identify the plurality of item types associated with the requests received from the third-party computer, and select a subset of target item types. For each target item type, the recommendation computing device 102 and/or the cloud-based engine 121 further select a set of boosting items from a set of target items of the respective target item type, consolidate the sets of boosting items of the subset of target item types, and generate an ordered list of boosting information items for the subset of target item types. For each target item type, the set of boosting items correspond to one or more boosting information items describing the set of boosting items. The boosting information items of the subset of target item types are consolidated to form the ordered list of boosting information items. Additionally, each boosting information item in the ordered list may have an item score quantitatively indicating an importance of the boosting information item.

In some embodiments, the ordered list of boosting information items is provided with one or more additional information items to the third-party computer, which forwards the plurality of requests to the recommendation computing device 102 and/or the cloud-based engine 121, and the one or more additional information items may be less important than the boosting information items. The third-party computer may present information items that are selected from the ordered list of boosting information items and the additional information items based partially on whether the information items are in the ordered list and/or their associated item scores. In some embodiments, a total number of the boosting information items and the additional information items may be greater than 40,000,000 and a number of the boosting information items may be greater than 10,000,000. Such information items may correspond to more than 4000 item types in total and the target item types may include more than 300 item types, for example, each of which may correspond to thousands of items differing in package size, brand, price, manufacturer, and other item parameters. Computer technology must to be applied to organize the information efficiently and identify the most relevant information items to be shared with the third-party computer.

FIG. 2 is a block diagram of a computing device 200, in accordance with some embodiments of the present teaching. In some embodiments, each of the recommendation computing device 102, the web server 104, the workstation(s) 106, the user computing devices 110, 112, 114, and/or the one or more processing devices 120 in FIG. 1 may include the features shown in FIG. 2. Referring to FIG. 2, the computing device 200 includes one or more of: one or more processors 201, a working memory 202, one or more input/output devices 207, an instruction memory 203, a transceiver 204, one or more communication ports 209, a display 206 with a user interface 205, and an optional location device 211, all operatively coupled to one or more data buses 208. The data buses 208 allow for communication among the various devices. The data buses 208 can include wired, or wireless, communication channels.

The processors 201 can include one or more distinct processors, each having one or more cores. Each of the distinct processors can have the same or different structure. The processors 201 can include one or more central processing units (CPUs), one or more graphics processing units (GPUs), application specific integrated circuits (ASICs), digital signal processors (DSPs), and the like.

The instruction memory 202 can store instructions that can be accessed (e.g., read) and executed by the processors 201. For example, the instruction memory 202 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. The processors 201 can be configured to perform a certain function or operation by executing code, stored on the instruction memory 202, embodying the function or operation. For example, the processors 201 can be configured to execute code stored in the instruction memory 202 to perform one or more of any function, method, or operation disclosed herein.

Additionally, the processors 201 can store data to, and read data from, the working memory 202. For example, the processors 201 can store a working set of instructions to the working memory 202, such as instructions loaded from the instruction memory 202. The processors 201 can also use the working memory 202 to store dynamic data created during the operation of the recommendation computing device 102. The working memory 202 can be a random access memory (RAM) such as a static random access memory (SRAM) or dynamic random access memory (DRAM), or any other suitable memory.

The input-output devices 207 can include any suitable device that allows for data input or output. For example, the input-output devices 207 can include one or more of a keyboard, a touchpad, a mouse, a stylus, a touchscreen, a physical button, a speaker, a microphone, or any other suitable input or output device.

The communication port(s) 209 can include, for example, a serial port such as a universal asynchronous receiver/transmitter (UART) connection, a Universal Serial Bus (USB) connection, or any other suitable communication port or connection. In some examples, the communication port(s) 209 allows for the programming of executable instructions in the instruction memory 202. In some examples, the communication port(s) 209 allow for the transfer (e.g., uploading or downloading) of data, such as model training data.

The display 206 can be any suitable display, and may display the user interface 205. The user interfaces 205 can enable user interaction with the recommendation computing device 102. For example, the user interface 205 can be a user interface for an application of a retailer that allows a customer to view and interact with a retailer's website. In some examples, a user can interact with the user interface 205 by engaging the input-output devices 207. In some examples, the display 206 can be a touchscreen, where the user interface 205 is displayed on the touchscreen.

The transceiver 204 allows for communication with a network, such as the communication network 118 of FIG. 1. For example, if the communication network 118 of FIG. 1 is a cellular network, the transceiver 204 is configured to allow communications with the cellular network. In some examples, the transceiver 204 is selected based on the type of the communication network 118 the recommendation computing device 102 will be operating in. The processor(s) 201 is operable to receive data from, or send data to, a network, such as the communication network 118 of FIG. 1, via the transceiver 204.

The optional location device 211 may be communicatively coupled to one or more location services and/or devices and operable to receive position data from the corresponding location services. For example, the location device 211 may receive position data identifying a latitude, and longitude, from a satellite of a positioning constellation. Based on the position data, the recommendation computing device 102 may determine a local geographical area (e.g., town, city, state, etc.) of its position.

In some embodiments, the computing device 200 is configured to implement a user application for a plurality of users 122 via service deployment, service execution, self-learning and fine tuning, and session knowledge enrichment. In some embodiments, the working memory 203, or alternatively the non-transitory computer readable storage medium of memory 202, stores the following programs, modules and data structures, instructions, or a subset thereof:
Operating system 212 that includes procedures for handling various basic system services and for performing hardware dependent tasks;
Communication module 214 that is used for connecting the computing device 200 to other machines (e.g., other devices 102, 104, 120, 106, 110, 112, 114, and/or 116 in the network environment 100) via one or more network communication ports 209 (wired or wireless) and one or more communication networks 118, such as the Internet, other wide area networks, local area networks, metropolitan area networks, and so on;
I/O module 216 that includes procedures for handling various basic input and output functions through one or more input and output devices;
User application 218 that is executed to provide server-side functionalities, where an example of the user application 218 is an online interface application that may provide online services to registered users and/or guest users; and
Item feed and ordering module 222 that is executed to obtain a plurality of requests associated with a plurality of items corresponding to a plurality of item types and generate an ordered list of boosting information items corresponding to items in a set of target item types selected from the plurality of item types, where in some embodiments, the item feed and ordering module 222 applies a boosting selection model 224 or a heuristic model 226 to generate the ordered list of boosting information item associated with the plurality of requests.

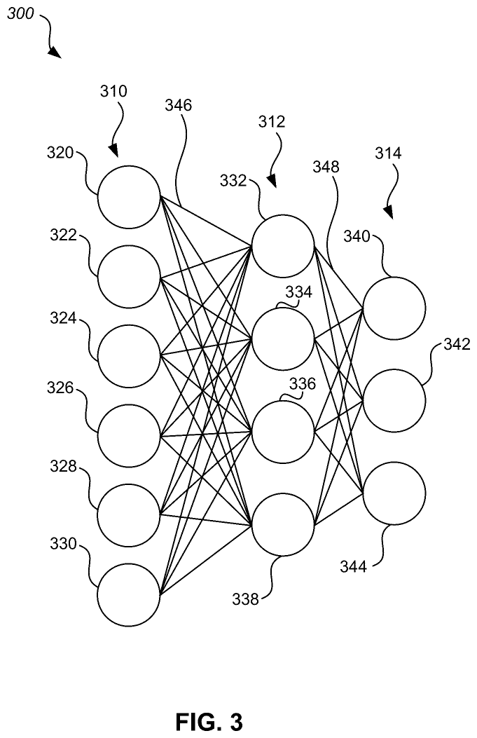

FIG. 3 illustrates an artificial neural network 300, in accordance with some embodiments. Alternative terms for “artificial neural network” are “neural network,” “artificial neural net,” “neural net,” or “trained function.” The neural network 300 comprises nodes 320-344 and edges 346-348, wherein each edge 346-348 is a directed connection from a first node 320-338 to a second node 332-344. In general, the first node 320-338 and the second node 332-344 are different nodes, although it is also possible that the first node 320-338 and the second node 332-344 are identical. For example, in FIG. 3 the edge 346 is a directed connection from the node 320 to the node 332, and the edge 348 is a directed connection from the node 332 to the node 340. An edge 346-348 from a first node 320-338 to a second node 332-344 is also denoted as “ingoing edge” for the second node 332-344 and as “outgoing edge” for the first node 320-338.

The nodes 320-344 of the neural network 300 may be arranged in layers 310-314, wherein the layers may comprise an intrinsic order introduced by the edges 346-348 between the nodes 320-144 such that edges 346-348 exist only between neighboring layers of nodes. In the illustrated embodiment, there is an input layer 310 comprising only nodes 320-330 without an incoming edge, an output layer 314 comprising only nodes 340-344 without outgoing edges, and a hidden layer 312 in-between the input layer 310 and the output layer 314. In general, the number of hidden layer 312 may be chosen arbitrarily and/or through training. The number of nodes 320-330 within the input layer 310 usually relates to the number of input values of the neural network, and the number of nodes 340-344 within the output layer 314 usually relates to the number of output values of the neural network.

In particular, a (real) number may be assigned as a value to every node 320-344 of the neural network 300. Here, xᵢ⁽ⁿ⁾ denotes the value of the i-th node 320-344 of the n-th layer 310-314. The values of the nodes 320-330 of the input layer 310 are equivalent to the input values of the neural network 300, the values of the nodes 340-344 of the output layer 314 are equivalent to the output value of the neural network 300. Furthermore, each edge 346-348 may comprise a weight being a real number, in particular, the weight is a real number within the interval [−1, 1], within the interval [0, 1], and/or within any other suitable interval. Here, w_{i,j}^{(m,n)} denotes the weight of the edge between the i-th node 320-338 of the m-th layer 310, 312 and the j-th node 332-344 of the n-th layer 312, 314. Furthermore, the abbreviation w_{i,j}⁽ⁿ⁾ is defined for the weight w_{i,j}^{(n,n+1)}.

In particular, to calculate the output values of the neural network 300, the input values are propagated through the neural network. In particular, the values of the nodes 332-344 of the (n+1)-th layer 312, 314 may be calculated based on the values of the nodes 320-338 of the n-th layer 310, 312 by:

$${x}_{j}^{( n + 1 )} = f ( {Σ}_{i} {x}_{i}^{( n )} \cdot {w}_{i , j}^{( n )} ) \qquad ( 1 )$$

where the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 310 are given by the input of the neural network 300, wherein values of the hidden layer(s) 312 may be calculated based on the values of the input layer 310 of the neural network and/or based on the values of a prior hidden layer, etc.

In order to set the values w_{i,j}^{(m,n)} for the edges, the neural network 300 has to be trained using training data. In particular, training data comprises training input data and training output data. For a training step, the neural network 300 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 300 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )} \qquad ( 2 )$$

wherein γ is a learning rate, and the numbers δⱼ⁽ⁿ⁾ may be recursively calculated as

$${δ}_{j}^{( n )} = ( {Σ}_{k} {δ}_{k}^{( n + 1 )} \cdot {w}_{j , j}^{( n + 1 )} ) \cdot {f}^{′} ( {Σ}_{i} {x}_{i}^{( n )} \cdot {w}_{i , j}^{( n )} ) \qquad ( 3 )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {Σ}_{i} {x}_{i}^{( n )} \cdot {w}_{i , j}^{( n )} ) \qquad ( 4 )$$

if the (n+1)-th layer is the output layer 34, wherein f′ is the first derivative of the activation function, and yⱼ⁽ⁿ⁺¹⁾ is the comparison training value for the j-th node of the output layer 314.

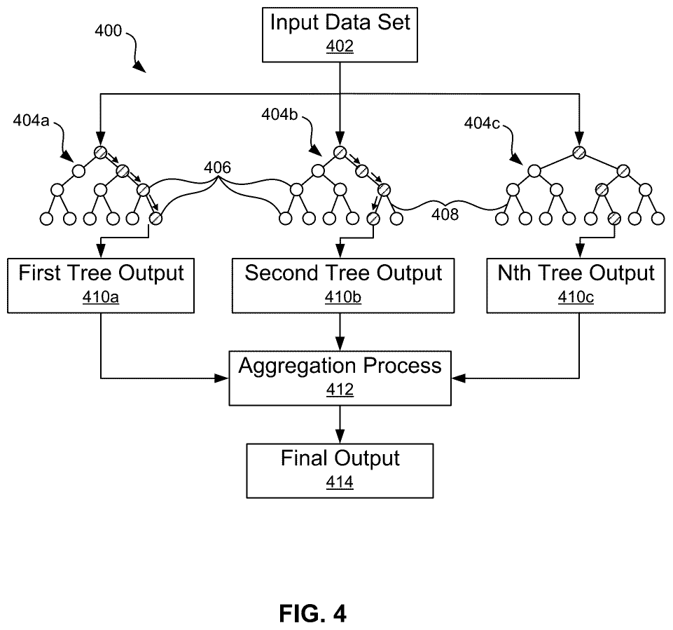

FIG. 4 illustrates a tree-based neural network 400, in accordance with some embodiments. In particular, the tree-based neural network 400 is a random forest neural network, though it will be appreciated that the discussion herein is applicable to other decision tree neural networks. The tree-based neural network 400 includes a plurality of trained decision trees 404a-404c each including a set of nodes 406 (also referred to as “leaves”) and a set of edges 408 (also referred to as “branches”).

Each of the trained decision trees 404a-404c may include a classification and/or a regression tree (CART). Classification trees include a tree model in which a target variable may take a discrete set of values, e.g., may be classified as one of a set of values. In classification trees, each leaf 406 represents class labels and each of the branches 408 represents conjunctions of features that connect the class labels. Regression trees include a tree model in which the target variable may take continuous values (e.g., a real number value).

In operation, an input data set 402 including one or more features or attributes is received. A subset of the input data set 402 is provided to each of the trained decision trees 404a-404c. The subset may include a portion of and/or all of the features or attributes included in the input data set 402. Each of the trained decision trees 404a-404c is trained to receive the subset of the input data set 402 and generate a tree output value 410a-410c, such as a classification or regression output. The individual tree output value 410a-410c is determined by traversing the trained decision trees 404a-404c to arrive at a final leaf (or node) 406.

In some embodiments, the tree-based neural network 400 applies an aggregation process 412 to combine the output of each of the trained decision trees 404a-404c into a final output 414. For example, in embodiments including classification trees, the tree-based neural network 400 may apply a majority-voting process to identify a classification selected by the majority of the trained decision trees 404a-404c. As another example, in embodiments including regression trees, the tree-based neural network 400 may apply an average, mean, and/or other mathematical process to generate a composite output of the trained decision trees. The final output 414 is provided as an output of the tree-based neural network 400.

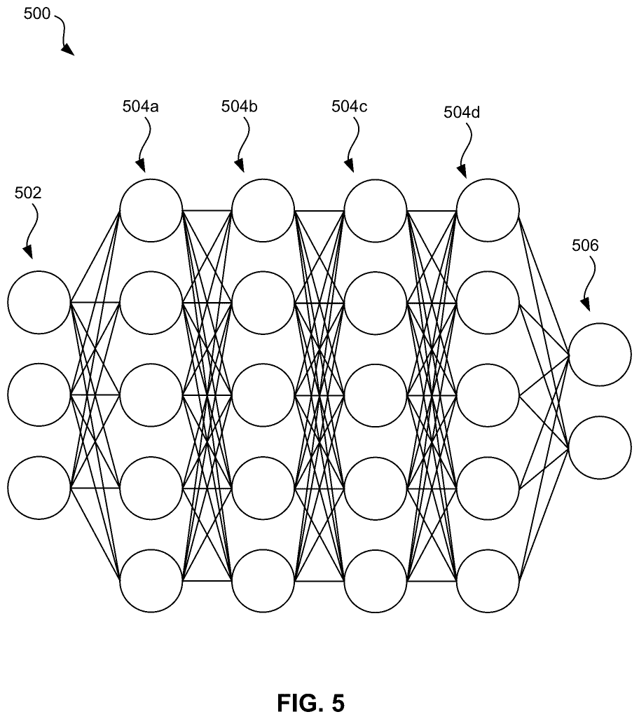

FIG. 5 illustrates a deep neural network (DNN) 500, in accordance with some embodiments. The DNN 500 is an artificial neural network, such as the neural network 300 illustrated in conjunction with FIG. 3, that includes representation learning. The DNN 500 may include an unbounded number of (e.g., two or more) intermediate layers 504a-504d each of a bounded size (e.g., having a predetermined number of nodes), providing for practical application and optimized implementation of a universal classifier. Each of the layers 504a-504d may be heterogenous. The DNN 500 may be configured to model complex, non-linear relationships. Intermediate layers, such as intermediate layer 504c, may provide compositions of features from lower layers, such as layers 504a, 504b, providing for modeling of complex data.

In some embodiments, the DNN 500 may be considered a stacked neural network including multiple layers each configured to execute one or more computations. The computation for a network with L hidden layers may be denoted as:

$$f ( x ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ] \qquad ( 5 )$$

where a^{(l)}(x) is a preactivation function and h^{(l)}(x) is a hidden-layer activation function providing the output of each hidden layer. The preactivation function a^{(l)}(x) may include a linear operation with matrix W^{(l)} and bias b^{(l)} where:

$${a}^{( l )} ( x ) = {W}^{( l )} x + {b}^{( l )} \qquad ( 6 )$$

In some embodiments, the DNN 500 is a feedforward network in which data flows from an input layer 502 to an output layer 506 without looping back through any layers. In some embodiments, the DNN 500 may include a backpropagation network in which the output of at least one hidden layer is provided, e.g., propagated, to a prior hidden layer. The DNN 500 may include any suitable neural network, such as a self-organizing neural network, a recurrent neural network, a convolutional neural network, a modular neural network, and/or any other suitable neural network.

In some embodiments, a DNN 500 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + … + {f}_{K} ( {x}_{K} ) \qquad ( 7 )$$

where β is an offset and each fᵢ is parametrized by a neural network. In some embodiments, the DNN 500 may include a neural multiplicative model (NMM), including a multiplicative form for the NAM mode using a log transformation of the dependent variable y and the independent variable x:

$$y = {e}^{β} {e}^{f ( log x )} {e}^{{Σ}_{i} {f}_{i}^{d} ( {d}_{i} )} \qquad ( 8 )$$

where d represents one or more features of the independent variable x.

It will be appreciated that automated boosting item identification, as disclosed herein, particularly for large platforms such as e-commerce network platforms, is only possible with the aid of computer-assisted machine-learning algorithms and techniques, such as the disclosed boosting selection model 224. In some embodiments, item feed and ordering processes including the trained boosting selection model 224 are used to perform operations that cannot practically be performed by a human, either mentally or with assistance. Such operations include, but not limited to, automated extraction of information of a plurality of items from a database (e.g., a database 116 in FIG. 1) and identification of associated item types based on the extracted information. In some situations, the database stores information of millions of items, which cannot practically be processed by a human. It will be appreciated that a variety of item feed and ordering techniques can be used alone or in combination to further determine a list of boosting information items corresponding to target item types in the context of requests receives from a third-party computer (e.g., 802 in FIG. 8).

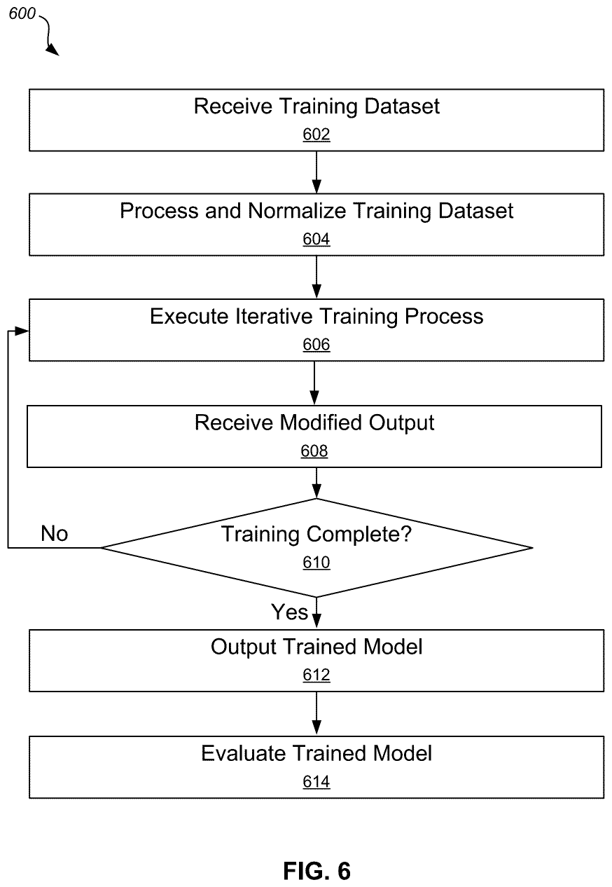

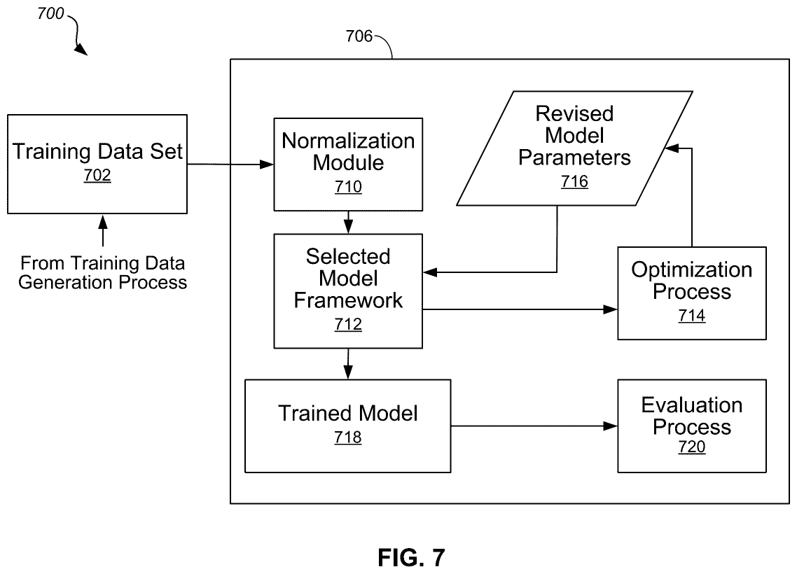

In some embodiments, an item recommendation method can include and/or implement one or more trained models, such as a boosting selection model 224. In some embodiments, one or more trained models can be generated using an iterative training process based on a training dataset. FIG. 6 illustrates a method 600 for generating a trained model, such as a trained optimization model, in accordance with some embodiments. FIG. 7 is a process flow 700 illustrating various steps of the method 600 of generating a trained model (e.g., a trained boosting selection model 224 in FIG. 2), in accordance with some embodiments. At step 602, a training dataset 702 is received by a system 706, such as a processing device 120. The training dataset 702 can include labeled and/or unlabeled data. For example, in some embodiments, a set of training data is provided for use in training a model, as discussed above.

At optional step 604, the received training dataset 702 is processed and/or normalized by a normalization module 710. For example, in some embodiments, the training dataset 702 can be augmented by imputing or estimating missing values or features of one or more screenshots.

At step 606, an iterative training process is executed to train a selected model framework 712. The selected model framework 712 can include an untrained (e.g., base) boosting selection model 224, such as a DNN-based framework and/or a partially or previously trained model (e.g., a prior version of a trained model). The training process is configured to iteratively adjust parameters (e.g., hyperparameters) of the selected model framework 712 to minimize a cost value (e.g., an output of a cost function) for the selected model framework 712.

At step 608, the training process is an iterative process that generates set of revised model parameters 716 and the output of the cost function during each iteration. The set of revised model parameters 716 can be generated by applying an optimization process 714 to the cost function of the selected model framework 712. The optimization process 714 can be configured to reduce the cost value (e.g., reduce the output of the cost function) at each step by adjusting one or more parameters during each iteration of the training process.

After each iteration of the training process, at step 610, a determination is made whether the training process is complete. The determination at step 610 can be based on any suitable parameters. For example, in some embodiments, a training process can complete after a predetermined number of iterations. As another example, in some embodiments, a training process can complete when it is determined that the cost function of the selected model framework 712 has reached a minimum, such as a local minimum and/or a global minimum.

At step 612, a trained model 718 is output and provided for use in determining query-item ranking and/or ranking items. At optional step 614, a trained model 718 can be evaluated by an evaluation process 720. A trained model can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

FIG. 8 is a flow diagram of a process 800 of providing a plurality of candidate information items to a third-party computer 802, in accordance with some embodiments. The process 800 may be implemented by any suitable system (e.g., including a recommendation computing device 102 and/or a cloud-based engine 121 in FIG. 1). A first user application 218 (FIG. 2) associated with a plurality of first users 122 (e.g., registered users, guest users) and having a plurality of user accounts is executed. A plurality of requests 804 associated with a plurality of items 806 corresponding to a plurality of item types 818 is received from a third-party computer 802 and information of a plurality of candidate information items 808C is provided to the third-party computer 802. The third-party computer 802 executes a second user application associated with a plurality of second users and may select one or more information items 808S from the plurality of candidate information items 808C for display on a user interface 812 of the second user application. Each of the plurality of requests 804 may be associated with a respective second user's action on one of the one or more information items 808S displayed on the user interface 812. In response to each of the plurality of requests 804, the respective second user of the second user application may be guided to the first user application 218 and a user interface 814 of the first user application 218 is enabled by the system and displayed to present information associated with the information item 808S. The respective second user may be further engaged by clicking on an affordance item 816 (e.g., “Add to Cart”) on the user interface 814 of the first user application 218.

The plurality of requests 804 identify information items 808S that may attract user interest and result in further engagement. The user interest and further engagement may depend on a relevance level of the information items 808S displayed on the user interface 812. The relevance level of the information items 808S further depends on a relevance level of the plurality of candidate information items 808C. The plurality of requests 804 may be monitored and the plurality of candidate information items 808C may be generated and/or updated dynamically based on the plurality of requests 804, thereby enhancing the relevance levels of the candidate information items 808C and 808S and increasing a probability of the second users being guided to the first user application 218 via the second user application. An item feed and ordering module 222 (FIG. 2) may be configured to determine that the plurality of requests 804 are associated with a plurality of items 806 corresponding to a plurality of item types 818. The item feed and ordering module 222 may further identify a subset of target item types 818T from the plurality of item types 818, and select boosting items 806B of the subset of target item types 818T corresponding to substantially high probabilities of guiding users to the first user application 218. The plurality of candidate information items 808C are generated to include at least the selected boosting items 806B, and information provided to the third-party computer 802 identifies the boosting items 806B among the plurality of candidate information items 808C.

Further, the plurality of candidate information items 808C provided to the third-party computer 802 may include a subset of remaining information items 808R in addition to the boosting information items 808B, which may be organized in an ordered list 820 of boosting information items 808B. The boosting information items 808B may have higher priority levels than the remaining information items 808R and each boosting information item 808B may have an item score 822 quantitatively indicating its importance level and priority level. In one non-limiting example, the third-party computer 802 is provided with information of the plurality of candidate information items 808C corresponding to forty million product items. The forty million product items may approximately include twelve million boosting items for which corresponding boosting information items 808B are provided with associated item scores 822 indicating a corresponding importance levels. Remaining information items 808R corresponding to remaining twenty-eight million items may be provided to the third-party computer 802 without any item scores 822, leaving the third-party computer 802 determine a priority level for each remaining information item 808R.

Under some circumstances, the item feed and ordering module 222 may monitor user engagement, content quality of the information items 808S, and/or item quality of the items 806 associated with the plurality of requests 804, and dynamically update the plurality of candidate information items 808C (e.g., by moving information items into or out of the list of boosting information items 808B), thereby enhancing a relevance level of the candidate information items 808C provided to the third-party computer 802. In an example, 63% of the plurality of requests 804 corresponds to the boosting information items 808B and a user selection rate of the boosting information items 808B is 60% among the plurality of requests 804. For each information item, the user selection rate corresponds to a weighted selection rate combining the user selection rate and a weight of the boosting information item 808B. The weight of the boosting information item 808B may be represented by a price of a corresponding item 806. In some embodiments, a sum of the weighted selection rates of the boosting information items 808B exceeds that of the remaining information items 808R by 40%. In some embodiments, the higher an item score 822 of a boosting information item 808B, the higher a corresponding weighted selection rate of the boosting information item 808B (e.g., the higher a revenue created by the boosting information item 808B).

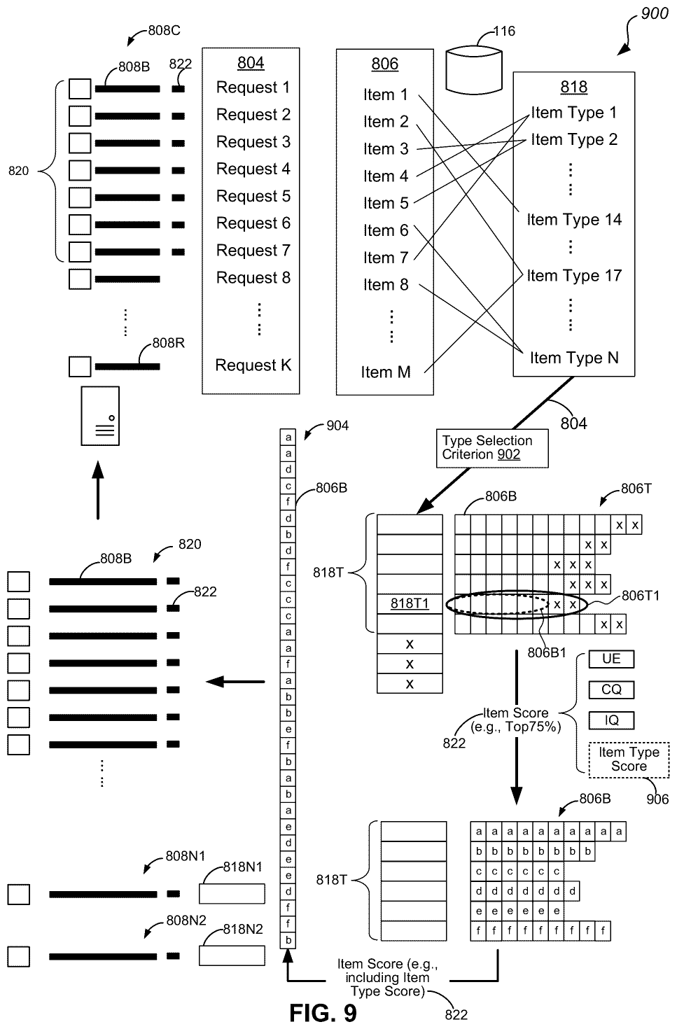

In some embodiments, a database 116 includes an item database 116P configured to provide a collection of information items 808. The plurality of candidate information items 808C provided to the third-party computer 802 may be selected from the collection of information items 808 based on the target item types 818T, which may be further selected from the plurality of item types 818 associated with the plurality of requests 804 received from the third-party computer 802. In some embodiments, the system determines a weighted selection rate of each of the plurality of item types 818 associated with the plurality of requests 804. For a respective item type 818, a weighted selection rate combines a product of a user selection rate and a weight of each of one or more information items 808S of the respective item type 818, e.g., where the weight of a respective information item 808S is represented by a price of a corresponding item 806. The system determines a sum of the weighted selection rates of the plurality of item types 818 associated with the plurality of requests 804. The subset of target item types 818T satisfies a predefined type selection criterion (e.g., criterion 902 in FIG. 9), in accordance with a determination that (1) the subset of target item types 818T has the highest weighted selection rates among the plurality of item types 818 and (2) a sum of the weighted selection rates of the subset of target item types 818T reaches or exceeds the first predefined portion (e.g., 70%, 90%) of the sum of the weighted selection rates of the plurality of item types 818. In one non-limiting example, the plurality of item types 818 associated with the requests 804 received from the third-party computer 802 includes approximately 4000 item types, and the subset of target item types 818T includes approximately 300 item types.

FIG. 9 is a flow diagram of a process 900 of providing a plurality of candidate information items 808C including a list of boosting information items 808B to a third-party computer 802, in accordance with some embodiments. The process 900 may be implemented by any suitable system (e.g., including a recommendation computing device 102 and/or a cloud-based engine 121 in FIG. 1). During the process 900, a plurality of requests 804 (e.g., request 1, 2, . . . , K) associated with a plurality of items 806 (e.g., item 1, 2, . . . , M) corresponding to a plurality of item types 818 (e.g., item type 1, 2, . . . , N) is received, where K, M, N are positive integers. Each item type 818 may include one or more items 806, and M may be equal to or greater than N. Each request 804 may correspond to at least one item 806, and M may be equal to or greater than K. In some embodiments, information of the plurality of items 806 associated with the requests 804 is extracted from a database (e.g., a database 116 in FIG. 1), and used to identify associated item types 818, e.g., based on an item type classifier.

A subset of target item types 818T is selected from the plurality of item types 818 that satisfy a predefined type selection criterion 902 associated with the plurality of requests 804. For each of the subset of target item types 818T, the system selects a set of boosting items 806B from a set of target items 806T of the respective target item type 818T based on an item score 822 of each of the set of target items 806T. The sets of boosting items 806B of the subset of target item types 818T are consolidated, thereby generating an ordered list 904 of boosting items 806B. A list 820 of boosting information items 808B corresponds to the ordered list 904 of boosting items 806B and the subset of target item types 818T. Information of a plurality of candidate information items 808C including the list 820 of boosting information items 808B is provided to a third-party computer 802 (FIG. 8). In some embodiments, the information provided to the third-party computer 802 includes only differences between a current version and an earlier version of the candidate information items 808C. Alternatively, in some embodiments, the information provided to the third-party computer 802 includes the plurality of candidate information items 808C each of which corresponds to an item of a respective item type.

In some embodiments, for each of the subset of target item types 818T, the set of boosting items 806B includes a second predefined portion (e.g., 75%, 90%) of the set of target items 806T having the highest item scores among the set of target items 806T. For example, a first target item type 818T1 corresponds to a first set of target items 806T1 (e.g., having 8 target items), and the set of boosting items 806B1 includes 75% of the first set of target items 806T1 (i.e., the 8 target items of the first target item type 818T1 include 6 boosting items).

In some embodiments, for a first target item type 818T1, the item score 822 of each of the set of target items 806T1 of the first target item type 818T1 is determined based on one or more of: user engagement, content quality, and item quality associated with the respective target item 806T1, and used to select the set of boosting items 806B1 corresponding to the first target item type 818T1. Further, in some embodiments, for each of the first set of target items 806T1 of the first target item type 818T1, the system may determine a user engagement level L_{UE}, a content quality factor Q_{CQ}, and an item quality factor Q_{IQ} of the respective target item 806T1. The item score 822 of the respective target item 806T1 is determined based on at least a combination of the user engagement level L_{UE}, the content quality factor Q_{CQ}, and the item quality factor Q_{IQ}. For example, the item score 822 (ES) may be equal to a sum of the user engagement level L_{UE}, the content quality factor Q_{CQ}, and the item quality factor Q_{IQ} as follows:

$$E S = {L}_{U E} + {Q}_{C Q} + {Q}_{IQ} . \qquad ( 9 )$$

The item score 822 (ES) of the respective target item 806T1 may be used to determine whether the respective target item 806T1 is among the second predefined portion (e.g., 75%, 90%) of the first set of target items 806T1 having the highest item scores 822 and can be selected as a boosting item 806B1 corresponding to the first target item type 818T1. Additionally, in some embodiments, for each of the set of target items 806T1 of the first target item type 818T1, in accordance with a determination that a value of the user engagement level L_{UE}, the content quality factor Q_{CQ}, and the item quality factor Q_{IQ} of the respective target item 806T1 is missing, the system may apply a corresponding median value L_{UEM}, Q_{CQM}, or Q_{IQM} of user engagement, content quality, and item quality of the set of target items 806T1 of the first target item type 818T1 in place of the value that is missing. In some embodiments, each of the user engagement level L_{UE}, the content quality factor Q_{CQ}, and the item quality factor Q_{IQ} is normalized in a range of 0-1, inclusively, so is each of the median values L_{UEM}, Q_{CQM}, and Q_{IQM}. Further, in some embodiments, a min-max normalization operation may be applied on each of the parameters L_{UE}, Q_{CQ}, Q_{IQ}, L_{UEM}, Q_{CQM}, and Q_{IQM} to convert the respective parameter into the range of 0-1.

In some embodiments, the user engagement level L_{UE} is determined based on the plurality of requests 804 received from the third-party computer 802. Alternatively, the user engagement level L_{UE} is determined based on requests received from all users 122 associated with the system (e.g., all users of a user application 218 executed by the system), which include, and are not limited to, the plurality of requests 804. The content quality factor Q_{CQ} of each target item 806T1 may be determined based on a quality of information that is stored in a database 116 (FIG. 1) and describes the respective target item 806T1 (e.g., detailed description, brief description). The item quality factor Q_{IQ} of the respective target item 806T1 may be determined based on a quality of the respective target item 806T1, e.g., using feedback messages provided by a set of verified users 122.

Additionally, in some embodiments, for each target item type 818T, the system determines a type engagement level (ETS) based on a median value L_{UEM} of user engagement levels L_{UE} of the set of boosting items 806B, a type-level content quality factor based on a median value Q_{CQM} of content quality factors Q_{CQ} of the set of boosting items 806B, a type-level item quality factor based on a median value Q_{IQM} of item quality factors QQ of the set of boosting items 806B, and a type impact factor Q_{TI} of a subset of request 804 corresponding to the selected boosting items 806B of the respective target item type 818T. The system may determine the item type score 906 (ETS) based on a combination of the type engagement level, the type-level content quality factor, the type-level item quality factor, and the type impact factor Q_{TI}. For example, for a first target item type 818T1, the item type score 906 (ETS) may be equal to a sum of a type impact factor Q_{TI} and median values L_{UEM}, Q_{CQM}, and Q_{IQM} of the user engagement levels L_{UE}, the content quality factors Q_{CQ}, and the item quality factors Q_{IQ} of the set of selected boosting items 806B of each item type 818T as follows:

$$E T S = {L}_{U E M} + {Q}_{C Q M} + {Q}_{IQM} + {Q}_{TI} . \qquad ( 9 )$$

In some embodiments, the type impact factor Q_{TI} may be a ratio of a number of requests in the subset of request 804 corresponding to the selected boosting items 806B of the respective item type 818T and a total number of requests received by the system. Alternatively, in some embodiments, the type impact factor Q_{TI} may be a ratio between a weighted selection rate of the respective target item type 818T associated with a subset of requests and a total weighted selection rate of all item types 818 of the plurality of requests 804. The weighted selection rate of the respective target item type 818T associated with the subset of requests may be a product of a user selection rate and a weight of each boosting item 806B of the respective target item type 818T. The total weighted selection rate of all item types 818 of the plurality of requests 804 may be a sum of weighted selection rates of all item types 818 of the plurality of requests 804.

In some situations, for each of the sets of boosting items 806B of the subset of target item types 818T, the system determines the item score 822 (ES) of the boosting item 806B based on at least a combination of the item type score 906 (ETS) of a corresponding target item type 818T and a user engagement level L_{UE}, a content quality factor Q_{CQ}, and an item quality factor Q_{IQ} of the boosting item 806B. The item score 822 (ES) of the boosting item 806B may be applied to select boosting items 806B for each target item type 818T. Also, the item score 822 (ES) of the boosting item 806B may be applied to generate the ordered list 904 of boosting items 806B corresponding to the target item types 818T, thereby generating the ordered list 820 of boosting information items 808B. For example, the boosting items 806B of the subset of target item types 818T may be consolidated and ranked jointly using an updated item score 822 determined based on the item type score 906 (ETS). The item score 822 (ES) may be equal to a sum of the item type score 906 (ETS), the user engagement level L_{UE}, the content quality factor Q_{CQ}, and the item quality factor Q_{IQ} as follows:

$$E S = {L}_{U E} + {Q}_{C Q} + {Q}_{IQ} + ETS . \qquad ( 10 )$$

In some embodiments, the sets of boosting items 806B of the subset of target item types 818T may be consolidated, and the item score 822 may be applied to order the consolidated boosting items 806B to form the set of boosting items 806B of each target item type 808T (e.g., 818T1). Stated another way, the sets of boosting items 806B of the subset of target item types 818T may include the set of boosting items 806B of each target item type 818T. The ordered list 820 of boosting information items 808B may be generated by comparing the item scores of the boosting items 806B of the subset of target item types 808T with one another and forming the ordered list 820 of boosting information items 808B based on a descending order of the item scores ES of the sets of boosting items 806B corresponding to the ordered list 820 of boosting information items 808B.

In some embodiments, the ordered list 904 of boosting items 806B includes all of the boosting items 806B of the subset of target item types 818T. Alternatively, in some embodiments, the ordered list 904 of boosting items 806B includes a subset (e.g., less than all) of the boosting items 806B of the subset of target item types 818T. A filter may be applied to select the subset of boosting items 806B based on the item scores 822 (ES). In some embodiments, the system may arrange the ordered list 904 of boosting items 806B corresponding to the target item types 808T according to an item score based distribution, which is further converted to a normal distribution (e.g., by a box-box transformation, a log transformation, sub-score re-weighting, and/or Winsorization). The normal distribution is projected to a predefined range (e.g., 1-10, inclusively). In an example, the item scores 822 of the boosting items 806B are redistributed in the range of 1-10 using min-max rescaling, and used as the item scores 822 of the corresponding boosting information items 808B of the ordered list 820 of the boosting information items 808B provided to the third-party computer 802.

Based on the plurality of candidate information items 808C provided by the system, the third-party computer 802 may present one or more information items 808S on a user interface 812 (FIG. 8) of a second user application hosted by the third-party computer 802. The third-party computer 802 detects user actions on the information items 808S, and sends the plurality of requests 804 to the system. The plurality of requests 804 may be received from the third-party computer 802 during an extended duration of time (e.g., during past three months). Based on the plurality of requests 804, the plurality of candidate information items 808C is generated, updated, and/or provided to the third-party computer 802 periodically, upon request, or according to a predefined schedule. The plurality of candidate information items 808C includes at least a set of boosting information items 808B corresponding to the set of selected boosting items 806B of each item type 818T. Each boosting information item 808B may be provided to the third-party computer 802 with an item score 822 of a respective boosting item 806B, which indicates a priority level (also called an importance level) of the respective boosting information item 808B among the boosting information items 808B. Stated another way, the boosting information items 808B may be ordered into the ordered list of boosting information items 808B based on their associated item scores 822.

In some embodiments, the plurality of candidate information items 808C provided to the third-party computer 802 further includes a subset of remaining information items 808R that is associated with a subset of the plurality of items 806, and each remaining information item 808R is distinct from, and ranked lower than, the ordered list of boosting information items 808B. In some embodiments, a remaining information item 806 may correspond to one or more requests 804 and have smaller item scores 822 (indicating a lower engagement level, a lower content quality factor, and/or a layer item quality factor) than a boosting information item 808B associated with the same item type 818 with the remaining information item 806. Alternatively, in some embodiments, a remaining information item 806 may correspond to one or more requests 804 and an item type 818 distinct from the subset of target item types 818T.

In some embodiments, the plurality of candidate information items 808C provided to the third-party computer 802 further includes a new information item 808N1 associated with a new item that is distinct from any of the plurality of items 806 associated with the plurality of requests 804. The system determines a new item type 818N1 of the new item. In accordance with a determination that the new item type 818N1 is included in the plurality of item types 818, the system determines whether to add the new information item 808N1 into the ordered list of boosting information items 808B based on an item score 822 of the new item, the item scores 822 of a set of target items 806T corresponding to the new item type 818N1, and an item type score 906 (ETS) of the new item type 818N1. Stated another way, the new item is mixed with the set of target items 806T corresponding to the new item type 818N, and the corresponding new information item 808N1 may be selected and added into the list of boosting information items 808B if the new item ranks among a top portion (e.g., 75%) of the set of target items 806T.

Alternatively, in some embodiments, the plurality of candidate information items 808C provided to the third-party computer 802 includes a new information item 808N2 associated with a new item that is distinct from any of the plurality of items 806. The system determine a new item type 818N2 of the new item. In accordance with a determination that the new item type 818N2 is not included in the plurality of item types 818, the system determines whether to add the new information item 808N to the list of boosting information items 808B or leave new information item 808N out of the list of boosting information items 808B based on an expected engagement level of the new information item 808N2. In some situations, in accordance with a determination that the new item type 818N2 is not included in the plurality of item types 818, the system aborts adding the new information item 808N in the list of boosting information items 808B, while adding the new information items 808N in the plurality of candidate information items 808C.

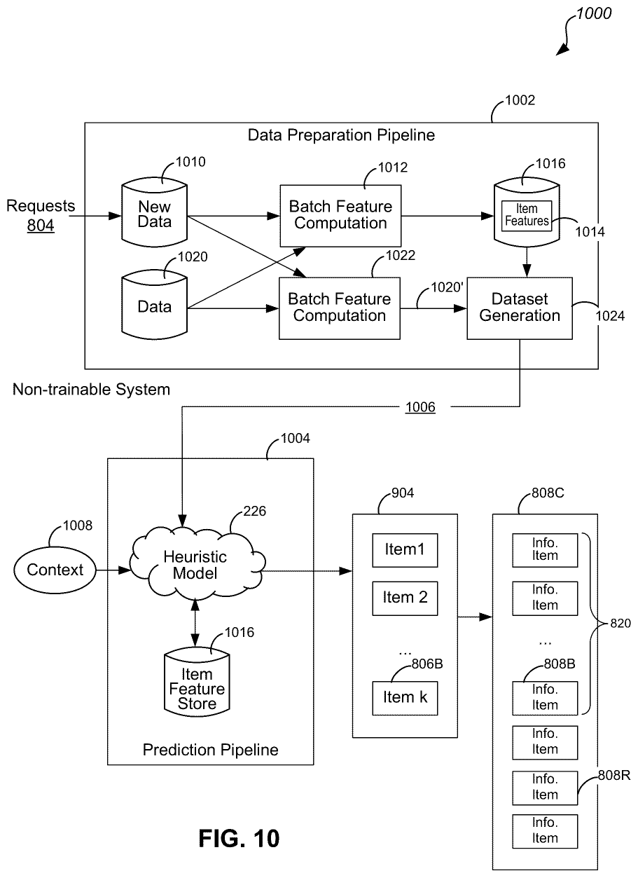

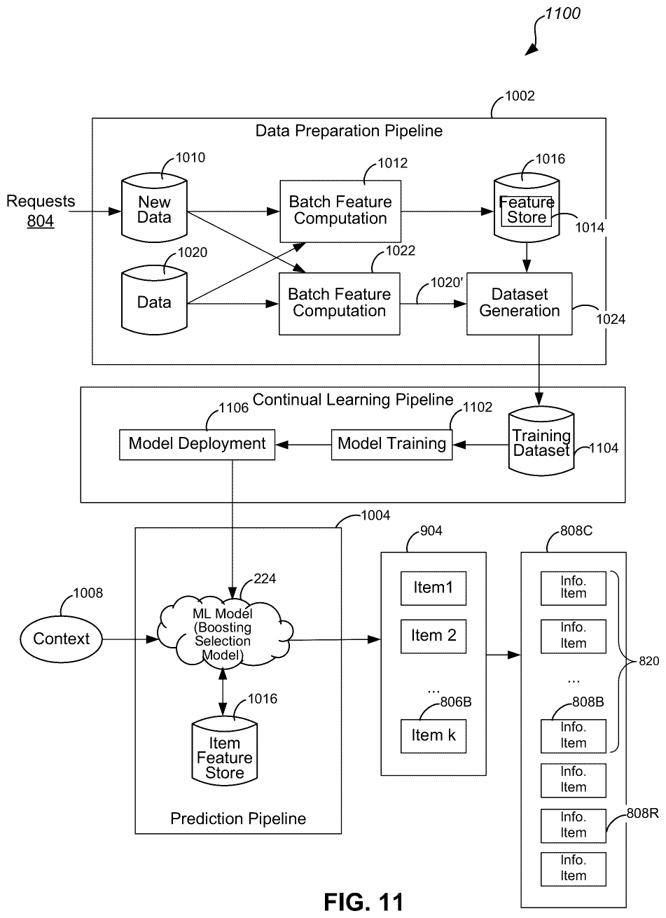

FIGS. 10 and 11 are block diagrams of information management systems 1000 and 1100, in accordance with some embodiments, respectively. Each of the information management systems 1000 and 1100 may include a recommendation computing device 102 and/or a cloud-based engine 121 in FIG. 1. Each of the information management systems 1000 and 1100 includes a data preparation pipeline 1002 and a prediction pipeline 1004. The data preparation pipeline 1002 receives a plurality of requests 804 from a third-party computer 802 (FIG. 2), and may generate item interaction information 1006 of at least a plurality of items 806 associated with the plurality of requests 804. The item interaction information 1006 is provided to the prediction pipeline 1004. The prediction pipeline 1004 obtains context information 1008 and processes the item interaction information 1006 and the context information 1008 jointly to generate a list 904 of boosting items 806B. Based on the list 904 of boosting items 806B, an ordered list 820 of boosting information items 806B is generated and provided to the third-party computer 802 with one or more remaining information items 808R that are not ordered. Stated another way, the information management system 1000 or 1100 may provide information of a plurality of candidate information items 808C to the third-party computer 802, and the plurality of candidate information items 808C may include a set of boosting information items 808B, their associated item scores 822 identifying an order of these boosting information items 808B, and one or more remaining information items 808R. The boosting information items 808B are used by the third-party computer 802 with priority levels indicated by the item scores 822, and the one or more remaining information items 808R may have lower priority levels than the boosting information items 808B when the remaining information items 808R are used by the third-party computer 802.

After receiving the plurality of requests 804 from the third-party computer 802, the data preparation pipeline 1002 may analyze the plurality of requests 804 to identify a plurality of items 806 and extract item information 1010 associated with the plurality of items 806 from a database 116. The item information 1010 is further processed (operation 1012) to determine item features 1014 to be temporarily stored in memory 1016 of the information management system 1000. The data preparation pipeline 1002 may also obtain supplemental information 1020 associated with the plurality of items 806 from the database 116, and process (operation 1022) the supplemental information 1020 in the background. The processed supplemental information 1020′ and the item features 1014 are applied to determine (operation 1024) the item interaction information 1006.

Referring to FIG. 10, in some embodiments, a heuristic model 226 (FIG. 2) is applied to determine the ordered list 820 of boosting information items 808B from the item interaction information 1006 associated with the plurality of requests 804. The prediction pipeline 1004 may apply the heuristic model 226 to process the item interaction information 1006 and context information 1008 to determine a list 904 of boosting items 806B and an associated list 820 of boosting information items 808B. The context information 1008 includes information of an item type 818; a selection rate, a weight, and a weighted selection rate of the item type 818; and corresponding request times of each of the plurality of items 806 associated with the plurality of requests 804. More details on determining the ordered list 820 of boosting information items 808B based on the requests received from the third-party computer 802 are discussed above with reference to FIGS. 8 and 9.

Referring to FIG. 11, in some embodiments, a boosting selection model 224 (FIG. 2) is applied to determine the ordered list 908C of boosting information items 808B from the item interaction information 1006 associated with the plurality of requests 804. The prediction pipeline 1004 may apply the boosting selection model 224 to process the item interaction information 1006 and context information 1008 to determine a list 904 of boosting items 806B and an associated list 820 of boosting information items 808B. For example, the boosting selection model 224 includes a deep neural network (FIG. 5), and each item 806 may be classified to an item type 818 using a tree based neural network (FIG. 4) of the boosting selection model 224. In some embodiments, the boosting selection model 224 is trained (operation 1102) using a training data set 1104, and deployed (operation 1106) to process the item interaction information 1006. More details on training the boosting selection model 224 are discussed above with reference to FIGS. 6 and 7. More details on determining the ordered list 820 of boosting information items 808B based on the requests 804 received from the third-party computer 802 are discussed above with reference to FIGS. 8 and 9.

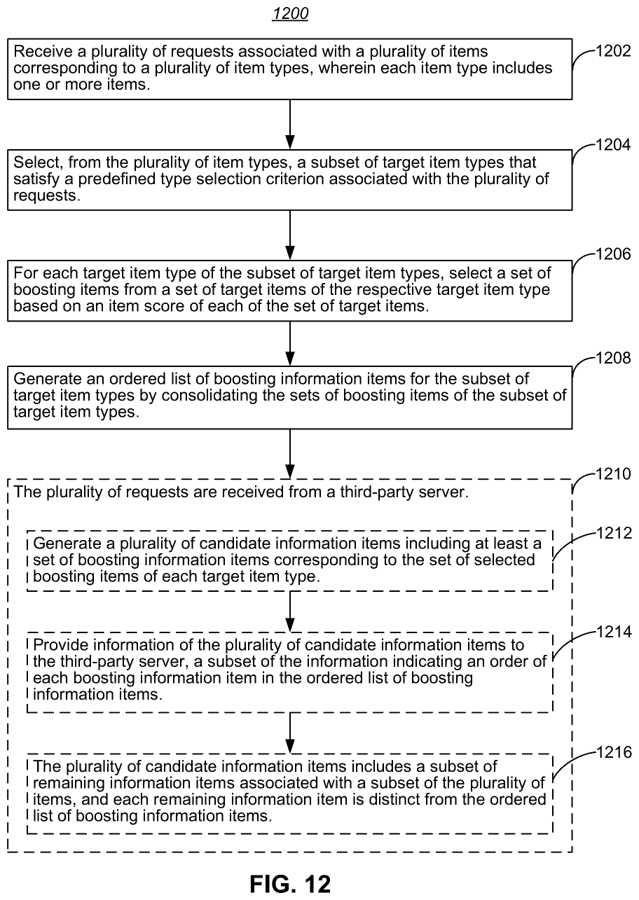

FIG. 12 is a flowchart illustrating a method 1200 for managing information, in accordance with some embodiments. The method 1200 is implemented by a system (e.g., including a recommendation computing device 102 and/or a cloud-based engine 121 in FIG. 1). Method 1200 may be governed by instructions that are stored in a non-transitory computer readable storage medium and that are executed by one or more processors of a system (e.g., a recommendation computing device 102). Each of the operations shown in FIG. 12 may correspond to instructions stored in a computer memory or non-transitory computer readable storage medium (e.g., memory 202 in FIG. 2). The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in method 1200 may be combined and/or the order of some operations may be changed.

A system (a recommendation computing device 102 and/or the cloud-based engine 121 in FIG. 1) receives (operation 1202) a plurality of requests 804 associated with a plurality of items 806 corresponding to a plurality of item types 818 (FIG. 8). Each item type 818 includes one or more items 806. The system selects (operation 1204), from the plurality of item types 818, a subset of target item types 818T that satisfy a predefined type selection criterion 902 (FIG. 9) associated with the plurality of requests 804. For each target item type 818T of the subset of target item types 818T, the system selects (operation 1206) a set of boosting items 806B from a set of target items 806T of the respective target item type 818T based on an item score 822 of each of the set of target items 806T, and generates (operation 1208) an ordered list 820 of boosting information items 808B for the subset of target item types 818T by consolidating the sets of boosting items 806B of the subset of target item types 818T.

In some embodiments, the system selects the subset of target item types 818T by determining a weighted selection rate of each of the plurality of item types 818 associated with a subset of respective requests 804. The predefined type selection criterion 902 is associated with the weighted selection rates of the plurality of item types 818. Further, in some embodiments, the system selects the subset of target item types 818T by determining a sum of the weighted selection rates of the plurality of item types 818 associated with the plurality of requests 804. The predefined type selection criterion 902 defines a first predefined portion (e.g., 90%) of the sum of the weighted selection rates of the plurality of item types 818. The system determines that the subset of target item types 818T satisfies the predefined type selection criterion 902, in accordance with a determination that (1) the subset of target item types 818T has the highest weighted selection rates among the plurality of item types 818 and (2) a sum of the weighted selection rates of the subset of target item types 818T reaches or exceeds the first predefined portion of the sum of the weighted selection rates of the plurality of item types 818.

In some embodiments, for each of the subset of target item types 818T, the set of boosting items 806B include a second predefined portion (e.g., 75%) of the set of target items 806T having the highest item scores 822 among the set of target items 806T.

In some embodiments, for a first target item type 818T1 (FIG. 9), the item score 822 of each of the set of target items 806T of the first target item type 818T1 is determined based on one or more of: user engagement, content quality, and item quality associated with the respective target item, and used to select the set of boosting items 806B corresponding to the first target item type 818T1. Further, in some embodiments, for each of the set of target items 806T of the first target item type 818T1, the system determines a user engagement level L_{UE} of the respective target item, a content quality factor Q_{CQ} of the respective target item 806T, an item quality factor Q_{IQ} of the respective target item 806T; and the item score 822 of the respective target item based on at least a combination of the user engagement level L_{UE}, the content quality factor Q_{CQ}, and the item quality factor Q_{IQ}. Additionally, in some embodiments, for each of the set of target items 806T of the first target item type 818T1, in accordance with a determination that a value of the user engagement level L_{UE}, the content quality factor Q_{CQ}, and the item quality factor Q_{IQ} of the respective target item 806T is missing, the system applies a corresponding median value L_{UEM}, Q_{CQM}, or Q_{IQM} of user engagement, content quality, and item quality of the set of target items 806T of the first target item type 818T1 in place of the value that is missing.

In some embodiments, for the sets of boosting items 806B of the subset of target item types 818T, the item score 822 of each boosting item 806B is determined based on both an item type score 906 (ETS) of the target item type 818T of the boosting item 806B and one or more of: user engagement, content quality, item quality, and request impact associated with the boosting item 806B. Further, in some embodiments, for each of the sets of boosting items 806B of the subset of target item types 818T, the system determines the item score 822 of the boosting item 806B based on at least a combination of the item type score 906 (ETS) of a corresponding target item type 818T and a user engagement level L_{UE}, a content quality factor Q_{CQ}, and an item quality factor Q_{IQ} of the boosting item 806B. The item score 822 of the boosting item 806B is applied to generate the ordered list 820 of boosting information items 808B.

Further, in some embodiments, the sets of boosting items 806B of the subset of target item types 818T includes the set of boosting items 806B of each target item type. The system generates the ordered list 820 of boosting information items 808B by comparing the item scores of the sets of boosting items 806B of the subset of target item types 818T and forming the ordered list 820 of boosting information items 808B based on a descending order of the item scores of the sets of boosting items 806B corresponding to the ordered list 820 of boosting information items 808B. Additionally, in some embodiments, the system associate the ordered list 820 of boosting information items 808B with the items cores and adjusting the item scores for the ordered list 820 of boosting information items 808B to comply with a predefined distribution.

Also, in some embodiments, for each target item type 818T, the system determines a type engagement level based on a median value of user engagement levels L_{UE} of the set of boosting items 806B, a type-level content quality factor based on a median value of content quality factors Q_{CQ} of the set of boosting items 806B, a type-level item quality factor based on a median value of item quality factors Q_{IQ} of the set of boosting items 806B, and a type impact factor between a weighted selection rate of the respective item type 818T associated with a subset of requests 804 and a total weighted selection rate of all item types 818 associated with the plurality of requests 804. The system determines the item type score based on a combination of the type engagement level, the type-level content quality factor, the type-level item quality factor, and the type impact factor Q_{TI}.

In some embodiments, the plurality of requests 804 are received (operation 1210) from a third-party computer 802. The system generates (operation 1212) a plurality of candidate information items 808C including at least a set of boosting information items 808B corresponding to the set of selected boosting items 806B of each target item type, and provides (operation 1214) information of the plurality of candidate information items 808C to the third-party computer 802. A subset of the information indicates an order of each boosting information item 808B in the ordered list 820 of boosting information items 808B. Further, in some embodiments, the plurality of candidate information items 808C includes (operation 1216) a subset of remaining information items 808R associated with a subset of the plurality of items 806, and each remaining information item 808R is distinct from the ordered list 820 of boosting information items 808B.

Further, in some embodiments, the plurality of candidate information items 808C includes a new information item 808N1 (FIG. 9) associated with a new item that is distinct from any of the plurality of items 806. The system determines a new item type 818N1 of the new item, and in accordance with a determination that the new item type 818N1 is included in the plurality of item types 818, determines whether to add to add the new information item 808N1 into the list of boosting information item based on an item score 822 of the new item, the item scores 822 of the set of target items 806T corresponding to the new item type 818N1, and an item type score 906 (ETS) of the new item type 818N1.

Further, in some embodiments, the plurality of candidate information items 808C includes a new information item 808N2 (FIG. 9) associated with a new item that is distinct from any of the plurality of items 806. The system determines a new item type 818N2 of the new item, and in accordance with a determination that the new item type 818N2 is not included in the plurality of item types 818, aborts adding the new information item 808N2 in the ordered list 820.

In some embodiments, a heuristic model 226 (FIGS. 2 and 10) is applied to determine the ordered list 820 of boosting information items 808B from information associated with the plurality of requests 804.

In some embodiments, an item feeding model 222 (FIGS. 2 and 11) is applied to determine the ordered list 820 of boosting information items 808B from information associated with the plurality of requests 804.

Turning now to example embodiments in the following clauses:
Clause 1. A system, comprising: a non-transitory memory having instructions stored thereon; and at least one processor operatively coupled to the non-transitory memory, and configured to read the instructions to: receive a plurality of requests associated with a plurality of items corresponding to a plurality of item types, wherein each item type includes one or more items; select, from the plurality of item types, a subset of target item types that satisfy a predefined type selection criterion associated with the plurality of requests; for each target item type of the subset of target item types, select a set of boosting items from a set of target items of the respective target item type based on an item score of each of the set of target items; and generate an ordered list of boosting information items for the subset of target item types by consolidating the sets of boosting items of the subset of target item types.
Clause 2. The system of clause 1, wherein selecting the subset of target item types further comprises determining a weighted selection rate of each of the plurality of item types associated with a subset of respective requests, wherein the predefined type selection criterion is associated with the weighted selection rates of the plurality of item types.
Clause 3. The system of clause 2, wherein the instructions to select the subset of target item types further comprises instructions to: determine a sum of the weighted selection rates of the plurality of item types associated with the plurality of requests, wherein the predefined type selection criterion defines a first predefined portion of the sum of the weighted selection rates of the plurality of item types; and determine that the subset of target item types satisfies the predefined type selection criterion, in accordance with a determination that (1) the subset of target item types has the highest weighted selection rates among the plurality of item types and (2) a sum of the weighted selection rates of the subset of target item types reaches or exceeds the first predefined portion of the sum of the weighted selection rates of the plurality of item types.
Clause 4. The system of any of clauses 1-3, wherein for each of the subset of target item types, the set of boosting items include a second predefined portion of the set of target items having the highest item scores among the set of target items.
Clause 5. The system of any of clauses 1-4, wherein for a first target item type, the item score of each of the set of target items of the first target item type is determined based on one or more of: user engagement, content quality, and item quality associated with the respective target item, and used to select the set of boosting items corresponding to the first target item type.
Clause 6. The system of clause 5, further comprising instructions to, for each of the set of target items of the first target item type: determine a user engagement level of the respective target item; determine a content quality factor of the respective target item; determine an item quality factor of the respective target item; and determine the item score of the respective target item based on at least a combination of the user engagement level, the content quality factor, and the item quality factor.
Clause 7. The system of clause 6, further comprising instructions to, for each of the set of target items of the first target item type, in accordance with a determination that a value of the user engagement level, the content quality factor, and the item quality factor of the respective target item is missing, apply a corresponding median value of user engagement, content quality, and item quality of the set of target items of the first target item type in place of the value that is missing.
Clause 8. The system of any of clauses 1-4, wherein for the sets of boosting items of the subset of target item types, the item score of each boosting item is determined based on both an item type score of the target item type of the boosting item and one or more of: user engagement, content quality, item quality, and request impact associated with the boosting item.
Clause 9. The system of clause 8, further comprising instructions to, for each of the sets of boosting items of the subset of target item types, determine the item score of the boosting item based on at least a combination of the item type score of a corresponding target item type and a user engagement level, a content quality factor, and an item quality factor of the boosting item, the item score of the boosting item is applied to generate the ordered list of boosting information items.
Clause 10. The system of clause 8, wherein the sets of boosting items of the subset of target item types includes the set of boosting items of each target item type, and the instructions to generate the ordered list of boosting information items further comprises instructions to: compare the item scores of the sets of boosting items of the subset of target item types; and form the ordered list of boosting information items based on a descending order of the item scores of the sets of boosting items corresponding to the ordered list of boosting information items.
Clause 11. The system of clause 10, further comprising instructions to: associate the ordered list of boosting information items with the items cores; and adjust the item scores for the ordered list of boosting information items to comply with a predefined distribution.
Clause 12. The system of any of clause 8-11, further comprising instructions to, for each target item type: determine a type engagement level based on a median value of user engagement levels of the set of boosting items; determine a type-level content quality factor based on a median value of content quality factors of the set of boosting items; determine a type-level item quality factor based on a median value of item quality factors of the set of boosting items; determine a type impact factor between a weighted selection rate of the respective target item type associated with a subset of requests and a total weighted selection rate of all item types associated with the plurality of requests; and determine the item type score based on a combination of the type engagement level, the type-level content quality factor, the type-level item quality factor, and the type impact factor.
Clause 13. The system of any of clauses 1-12, wherein the plurality of requests are received from a third-party computer, the system further comprising instructions to: generate a plurality of candidate information items including at least a set of boosting information items corresponding to the set of selected boosting items of each target item type; and provide information of the plurality of candidate information items to the third-party computer, a subset of the information indicating an order of each boosting information item in the ordered list of boosting information items.
Clause 14. The system of clause 13, wherein the plurality of candidate information items includes a subset of remaining information items associated with a subset of the plurality of items, and each remaining information item is distinct from the ordered list of boosting information items.
Clause 15. The system of clause 13 or 14, wherein the plurality of candidate information items includes a new information item associated with a new item that is distinct from any of the plurality of items, the system further comprising instructions to: determine a new item type of the new item; and in accordance with a determination that the new item type is included in the plurality of item types: determine whether to add to add the new information item into the list of boosting information item based on an item score of the new item, the item scores of the set of target items corresponding to the new item type, and an item type score of the new item type.
Clause 16. The system of clause 13 or 14, wherein the plurality of candidate information items includes a new information item associated with a new item that is distinct from any of the plurality of items, the system further comprising instructions to: determine a new item type of the new item; and in accordance with a determination that the new item type is not included in the plurality of item types, abort adding the new information item in the ordered list.
Clause 17. The system of any of clauses 1-16, wherein a heuristic model is applied to determine the ordered list of boosting information items from information associated with the plurality of requests.
Clause 18. The system of any of clauses 1-17, wherein an item feeding model is applied to determine the ordered list of boosting information items from information associated with the plurality of requests.
Clause 19. A non-transitory computer-readable storage medium, having instructions of any of claims 1-18 stored thereon, which when executed by one or more processors cause the one or more processors to implement operations based on.
Clause 20. A method, comprising: at a system including a non-transitory memory and at least one processor operatively coupled to the non-transitory memory: implementing operations based on instructions of any of claims 1-18 stored on the non-transitory memory.

It should be understood that the particular order in which the operations in FIG. 12 have been described are merely exemplary and are not intended to indicate that the described order is the only order in which the operations could be performed. One of ordinary skill in the art would recognize various ways to cache and distribute specific data as described herein. Additionally, it should be noted that details of other processes described herein with respect to FIGS. 8-13 are also applicable in an analogous manner to method 1200 described above with respect to FIG. 12. For brevity, these details are not repeated here.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a processor; and
a memory having instructions that when executed by the processor cause the processor to:
receive a plurality of requests associated with a plurality of items corresponding to a plurality of item types, wherein each item type includes one or more items;
select, from the plurality of item types, a subset of target item types that satisfy a predefined type selection criterion associated with the plurality of requests;
for each item type of the subset of target item types, select a set of boosting items from a set of target items of a respective target item type based on an item score of each of the set of target items; and
generate an ordered list of boosting information items for the subset of target item types by consolidating the sets of boosting items of the subset of target item types.

2. The system of claim 1, wherein selecting the subset of target item types further comprises:
determining a weighted selection rate of each of the plurality of item types associated with a subset of respective requests, wherein the predefined type selection criterion is associated with the weighted selection rates of the plurality of item types.

3. The system of claim 2, selecting the subset of target item types further comprises:
determining a sum of the weighted selection rates of the plurality of item types associated with the plurality of requests, wherein the predefined type selection criterion defines a first predefined portion of the sum of the weighted selection rates of the plurality of item types; and
determining that the subset of target item types satisfies the predefined type selection criterion, in accordance with a determination that (1) the subset of target item types has the highest weighted selection rates among the plurality of item types and (2) a sum of the weighted selection rates of the subset of target item types reaches or exceeds the first predefined portion of the sum of the weighted selection rates of the plurality of item types.

4. The system of claim 1, wherein for each of the subset of target item types, the set of boosting items include a second predefined portion of the set of target items having the highest item scores among the set of target items.

5. The system of claim 1, wherein for a first target item type, the item score of each of the set of target items of the first target item type is determined based on one or more of: user engagement, content quality, and item quality associated with the respective target item, and used to select the set of boosting items corresponding to the first target item type.

6. The system of claim 5, the memory further comprising instructions for, for each of the set of target items of the first target item type:
determining a user engagement level of the respective target item;
determining a content quality factor of the respective target item;
determining an item quality factor of the respective target item; and
determining the item score of the respective target item based on at least a combination of the user engagement level, the content quality factor, and the item quality factor.

7. The system of claim 6, the memory further comprising instructions for:
for each of the set of target items of the first target item type, in accordance with a determination that a value of the user engagement level, the content quality factor, and the item quality factor of the respective target item is missing, applying a corresponding median value of user engagement, content quality, and item quality of the set of target items of the first target item type in place of the value that is missing.

8. The system of claim 1, wherein for the sets of boosting items of the subset of target item types, the item score of each boosting item is determined based on both an item type score of the target item type of the boosting item and one or more of: user engagement, content quality, item quality, and request impact associated with the boosting item.

9. The system of claim 8, the memory further comprising instructions for:
for each of the sets of boosting items of the subset of target item types, determining the item score of the boosting item based on at least a combination of the item type score of a corresponding target item type and a user engagement level, a content quality factor, and an item quality factor of the boosting item, wherein the item score of the boosting item is applied to generate the ordered list of boosting information items.

10. The system of claim 8, wherein the sets of boosting items of the subset of target item types includes the set of boosting items of each target item type, and generating the ordered list of boosting information items further comprises:
comparing the item scores of the sets of boosting items of the subset of target item types; and
forming the ordered list of boosting information items based on a descending order of the item scores of the sets of boosting items corresponding to the ordered list of boosting information items.

11. The system of claim 10, the memory further comprising instructions for:
associating the ordered list of boosting information items with the items scores; and
adjusting the item scores for the ordered list of boosting information items to comply with a predefined distribution.

12. The system of claim 8, the memory further comprising instructions for, for each target item type:
determining a type engagement level based on a median value of user engagement levels of the set of boosting items;
determining a type-level content quality factor based on a median value of content quality factors of the set of boosting items;
determining a type-level item quality factor based on a median value of item quality factors of the set of boosting items;
determining a type impact factor between a weighted selection rate of the respective target item type associated with a subset of requests and a total weighted selection rate of all item types associated with the plurality of requests; and
determining the item type score based on a combination of the type engagement level, the type-level content quality factor, the type-level item quality factor, and the type impact factor.

13. A method, comprising:
at a system including a non-transitory memory having instructions stored thereon and at least one processor operatively coupled to the non-transitory memory and configured to read the instructions:
receiving a plurality of requests associated with a plurality of items corresponding to a plurality of item types, wherein each item type includes one or more items;
selecting, from the plurality of item types, a subset of target item types that satisfy a predefined type selection criterion associated with the plurality of requests;
for each item type of the subset of target item types, selecting a set of boosting items from a set of target items of a respective target item type based on an item score of each of the set of target items; and
generating an ordered list of boosting information items for the subset of target item types by consolidating the sets of boosting items of the subset of target item types.

14. The method of claim 13, wherein the plurality of requests are received from a third-party computer, the method further comprising:
generating a plurality of candidate information items including at least a set of boosting information items corresponding to the set of selected boosting items of each target item type; and
providing information of the plurality of candidate information items to the third-party computer, a subset of the information indicating an order of each boosting information item in the ordered list of boosting information items.

15. The method of claim 14, wherein the plurality of candidate information items includes a subset of remaining information items associated with a subset of the plurality of items, and each remaining information item is distinct from the ordered list of boosting information items.

16. The method of claim 14, wherein the plurality of candidate information items includes a new information item associated with a new item that is distinct from any of the plurality of items, the method further comprising:
determining a new item type of the new item; and
in accordance with a determination that the new item type is included in the plurality of item types: determining whether to add to add the new information item into the list of boosting information item based on an item score of the new item, the item scores of the set of target items corresponding to the new item type, and an item type score of the new item type.

17. The method of claim 14, wherein the plurality of candidate information items includes a new information item associated with a new item that is distinct from any of the plurality of items, the method further comprising:
determining a new item type of the new item; and
in accordance with a determination that the new item type is not included in the plurality of item types, aborting adding the new information item in the ordered list.

18. A non-transitory computer-readable storage medium, having instructions stored thereon, which when executed by one or more processors cause the processors to:
receive a plurality of requests associated with a plurality of items corresponding to a plurality of item types, wherein each item type includes one or more items;
select, from the plurality of item types, a subset of target item types that satisfy a predefined type selection criterion associated with the plurality of requests;
for each item type of the subset of target item types, select a set of boosting items from a set of target items of a respective target item type based on an item score of each of the set of target items; and
generate an ordered list of boosting information items for the subset of target item types by consolidating the sets of boosting items of the subset of target item types.

19. The non-transitory computer-readable storage medium of claim 18, wherein a heuristic model is applied to determine the ordered list of boosting information items from information associated with the plurality of requests.

20. The non-transitory computer-readable storage medium of claim 18, wherein an item feeding model is applied to determine the ordered list of boosting information items from information associated with the plurality of requests.
